(19) United States
(12) Patent Application Publication
(10) Pub. No.: US 2011/0252860 A1
(43) Pub. Date: Oct. 20, 2011

(54) METHOD FOR CONTROLLING TESTING APPARATUS

(75) Inventors: Haruyoshi Ono, Kanagawa (JP); Isao Baba, Kanagawa (JP); Makoto Sugiyama, Kanagawa (JP)

(73) Assignee: SUMITOMO ELECTRIC DEVICE INNOVATIONS, INC., Yokohama-shi (JP)

(21) Appl. No.: 13/168,726

(22) Filed: Jun. 24, 2011

Related U.S. Application Data
(63) Continuation of application No. PCT/JP2009/070681, filed on Dec. 10, 2009.

(30) Foreign Application Priority Data
Dec. 26, 2008 (JP) 2008-333509

(51) Int. Cl. G01D 18/00

(52) U.S. Cl. 73/1.01

(57) ABSTRACT

A method for controlling testing apparatus having a plurality of device stations for test, a plurality of measuring portions measuring an identical item, and a matrix switch changing a coupling combination between the plurality of the device stations for test and the plurality of the measuring portions, including: performing checking step of a measuring portion with respect to the plurality of the measuring portions, the checking step measuring the measuring portion by measuring a standard device; and performing checking step of a device station for test with respect to the plurality of the device stations for test, the checking step mounting a standard sample on the device station for test and checking the standard sample with use of the measuring portion coupled to the device station for test on which the standard sample is mounted.

### CROSS-REFERENCE TO RELATED APPLICATION

The present application is a continuation of and claims priority to International Patent Application No. PCT/JP2009/070681 filed on Dec. 10, 2009, which claims priority to Japanese Patent Application No. 2008-333509 filed on Dec. 26, 2008, subject matter of these patent documents is incorporated by reference herein in its entirety.

### BACKGROUND

(i) Technical Field

The present invention relates to a method for controlling testing device.

(ii) Related Art

A network type of testing device has a structure in which a plurality of device stations for test and a plurality of measuring devices are coupled to each other via a coupling portion. Japanese Patent Application Publication No. 2007-271588 discloses that a network type of testing device checks a device station for test on which a standard sample is mounted, with use of a plurality of stations for measuring.

### SUMMARY

There is no suggestion of a checking operation of the network type of testing device. The checking operation is an operation in which a standard device is mounted on a device station for test, characteristics of the standard device is measured with use of the station for measuring, and obtaining of an expected value is confirmed.

In generally a testing device, the device station for test and the station for measuring are coupled to each other by one-to-one. The checking of the testing device is finished when the standard device is mounted on the device station for test and the expected value is obtained by measuring the standard device with use of the station for measuring.

However, a plurality of stations for measuring that measure an identical item are mounted on the network type of testing device. It is not determined which station for measuring is coupled to the device station for test.

When the standard device is mounted on one of the device stations for test and is checked in the network type of testing device, the standard device is coupled to only one of the plurality of the stations for measuring. Therefore, the other stations for measuring cannot be checked with use of the standard device. It is not guaranteed that all stations for measuring are subjected to the checking, even if the other device stations for test are subjected to the checking operation.

It is an object of the present invention to provide a method for controlling testing device that allows normal checking even if any of a plurality of stations for measuring are used.

According to an aspect of the present invention, there is provided a method for controlling testing apparatus having a plurality of device stations for test, a plurality of measuring portions measuring an identical item, and a matrix switch changing a coupling combination between the plurality of the device stations for test and the plurality of the measuring portions, including: performing checking step of a measuring portion with respect to the plurality of the measuring portions, the checking step measuring the measuring portion by measuring a standard device; and performing checking step of a device station for test with respect to the plurality of the device stations for test, the checking step mounting a standard sample on the device station for test and checking the standard sample with use of the measuring portion coupled to the device station for test on which the standard sample is mounted.

According to another aspect of the present invention, there is provided a testing apparatus including: a plurality of device stations having a device for test and a drive portion driving the device for the test; a plurality of measuring portions measuring an identical item; a standard station having a standard device and a drive portion driving the standard device; and a matrix switch connecting between the device stations or the standard station and the plurality of the measuring portions.

### BRIEF DESCRIPTION OF THE DRAWINGS

FIG. 1 illustrates a schematic view of a testing device in accordance with a first embodiment;

FIG. 2A illustrates details of a device station to be tested;

FIG. 2B illustrates details of a measuring station;

FIG. 2C illustrates details of a standard station;

FIG. 3 illustrates an example of a flowchart of a method for controlling testing device executed by an external controller;

FIG. 4 illustrates a flowchart of another example of the method for controlling testing device;

FIG. 5 illustrates a flowchart of another example of the method for controlling testing device;

FIG. 6 illustrates a flowchart of another example of the method for controlling testing device; and

FIG. 7 illustrates a schematic view of a testing device in accordance with a fifth embodiment.

### DETAILED DESCRIPTION

A description will be given of a best mode for carrying the present invention.

### First Embodiment

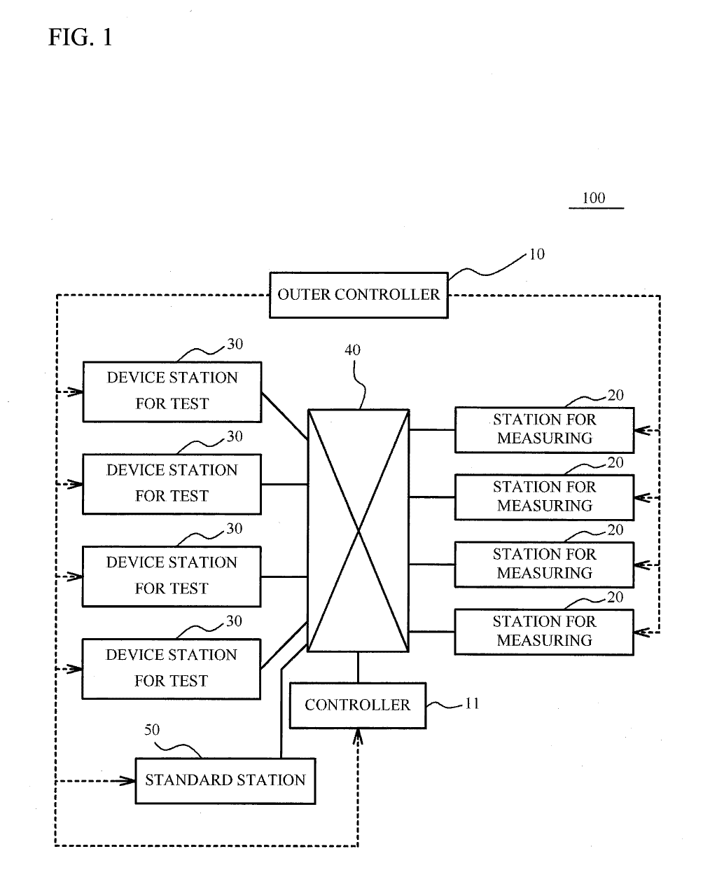

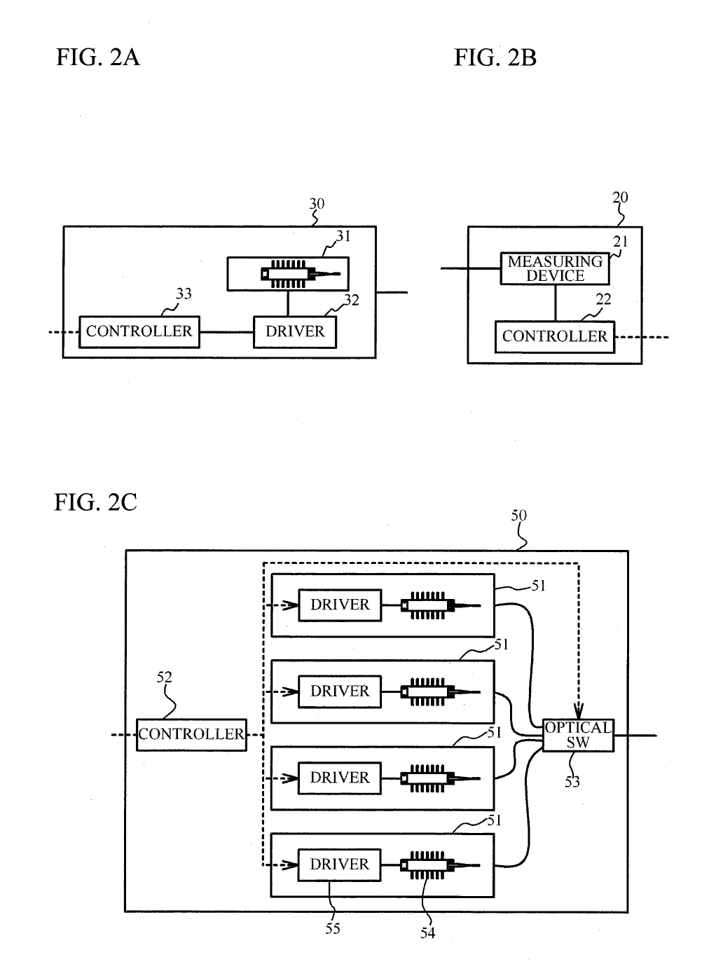

A description will be given of a testing device 100 in accordance with a first embodiment, with reference to FIG. 1 and FIG. 2A through FIG. 2C. FIG. 1 illustrates a schematic view of the testing device 100. FIG. 2A illustrates details of a device station 30 for test described later. FIG. 2B illustrates detail of a station 20 for measuring described later. FIG. 2C illustrates details of a standard station 50 described later.

As illustrated in FIG. 1, the testing device 100 includes an outer controller 10, a plurality of stations 20 for measuring, a plurality of device stations 30 for test, a matrix switch 40, and a controller 11.

The outer controller 10 and the controller 11 include a CPU (Central Processing Unit), ROM(Read Only Memory), RAM (Random Access Memory) and so on. The outer controller 10 controls the station 20 for measuring, the device station 30 for test, the controller 11 and the standard station 50.

The controller 11 receives an instruction from the outer controller 10, and controls the matrix switch 40. The matrix switch 40 receives an instruction from the controller 11, and changes a coupling combination of each station 20 form measuring, each device station 30 for test, and the standard station 50. In this case, each of the stations 20 for measuring is coupled to one of the device station 30 for test and the standard station 50.

As illustrated in FIG. 2A, each device station 30 for test includes a mount portion 31 mounting a device, a driver 32 and a controller 33. The controller 33 includes a CPU, a ROM, a RAM and so on, and controls the driver 32. The driver 32 receives an instruction from the controller 33 and drives a device mounted on the mount portion 31. In the embodiment, as an example, a semiconductor laser is mounted on the mount portion 31.

As illustrated in FIG. 2B, each station 20 for measuring includes a measuring device 21 and a controller 22. The controller 22 includes a CPU, a ROM, a RAM and so on and controls the measuring device 21. The measuring device 21 receives an instruction from the controller 22 and measures characteristics of the device mounted on the device station 30 for test coupled thereto through the matrix switch 40 or on the standard station 50. Each measuring device 21 can measure identical characteristics. The station 20 for measuring uses one of an optical oscilloscope, a power meter, a wavelength meter, a BER measuring device, a spectrum measuring device and so on as the measuring device 21. The above-mentioned each measuring device may be structured with a single measuring device or a plurality of measuring devices. The station 20 for measuring may include a plurality of combinations using a plurality of the measuring devices 21.

As illustrated in FIG. 2C, the standard station 50 includes one or more standard light source 51, a controller 52 and an optical switch 53. Each standard light source 51 includes a standard device 54 and a driver 55. The controller 52 includes a CPU, a ROM, a RAM and so on, and controls each driver 55 and the optical switch 53. Each driver 55 receives an instruction from the controller 52 and drives the standard device 54. It is confirmed in advance that the standard device 54 has predetermined characteristics. In the embodiment, a semiconductor laser is used as the standard device 54. The optical switch 53 receives an instruction from the controller 52 and selects a light source from the standard devices 54.

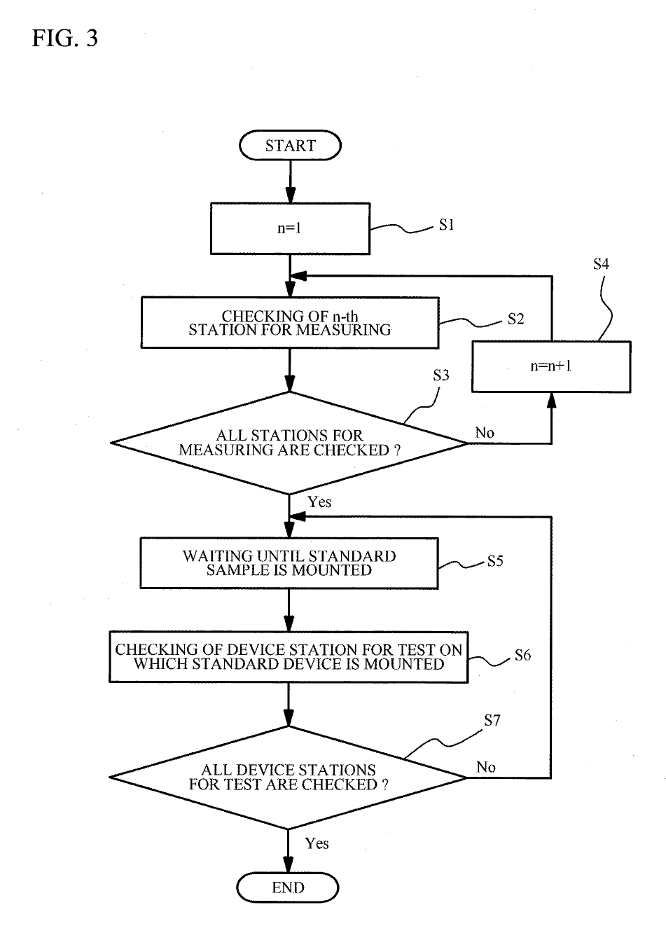

Next, a description will be given of a method for controlling the testing device 100. FIG. 3 illustrates a flowchart for controlling the testing device 100. The outer controller 10 executes the flowchart. The outer controller 10 substitutes “1” into a variable “n” (Step S1).

Next, the outer controller 10 checks nth station 20 for measuring with use of the standard device 54 of the standard station 50 (Step S2). In this case, the outer controller 10 controls the matrix switch 40 through the controller 11 so that the standard device 54 is coupled to the nth station 20 for measuring. With the execution of Step S2, it is confirmed whether the nth station 20 for measuring operates normally, and confirmed whether a path from the station 20 for measuring to the matrix switch 40 acts normally.

Next, the outer controller 10 determines whether all of the stations 20 for measuring are checked (Step S3). If it is determined “no” in Step S3, the outer controller 10 substitutes “n+1” into the variable “n” (Step S4). After that, the outer controller 10 executes Step S2 again.

If it is determined “yes” in step S3, the outer controller 10 waits until a standard sample is mounted on the mount portion 31 of the device station 30 for test that is not checked (Step S5). Here, the standard sample is the same type as the standard device. It is confirmed in advance that the standard sample has predetermined characteristics. In the embodiment, the standard sample is a semiconductor laser.

The outer controller 10 measures the standard sample with use of the station 20 for measuring that is checked, after the standard sample is mounted on the mount portion 31 of the device station 30 for test that is not checked (Step S6). In this case, the outer controller 10 controls the matrix switch 40 through the controller 11 so that the standard sample is coupled to the station 20 for measuring that is checked. With the execution of Step S6, it is detected whether there is a trouble in the device station 30 for test, a component or a path from the device station 30 for test to the matrix switch 40, or the like.

Next, the outer controller 10 determines whether all of the device stations for test are checked (Step S7). If it is determined “no” in Step S7, the outer controller 10 executes Step S5 again. If it is determined “yes” in Step S7, the outer controller 10 terminates the flowchart.

Checking frequency of the device station for test may be the same as that of the station for measuring and may be different from that of the station for measuring. For example, checking of any of the stations for test is guaranteed at the checking of the device station for test, if the checking frequency of the station for measuring is higher than that of the device station for test. This allows reducing waiting time for the checking of the station for measuring at the checking of the device station for test.

In accordance with the embodiment, the device station 30 for test is checked with use of the station 20 for measuring that is checked, when the checking step of the station 20 for measuring and the checking step of the device station 30 for test are performed separately. In this case, a normal checking is performed even if the device station 30 for test to be subjected to the checking is coupled to any of the stations 20 for measuring that are checked. In a general testing device in which a device station for test and a station for measuring are coupled to each other by one-to-one, a combination of a device station for test and a station for measuring is fixed. Therefore, it is not necessary to perform the checking step of a station for measuring and the checking step of a device station for test separately.

In accordance with the embodiment, a dedicated standard station 50 for mounting the standard device is provided. In this case, a process for mounting the standard device on the device station 30 for test may be reduced. Generally, a jig for mounting a device station for test is different from each other with respect to each type. Therefore, the number of processes may increase when each jig is exchanged. However, when a standard station is provided, a dedicated standard device may be included in the standard station 50. Therefore, the number of processes for exchanging each jig may be reduced.

When the standard station is used, it is possible to reduce influence of desorption of the standard device on the jig of the device station for test on the characteristics. The checking of the station for measuring is performed automatically, if the standard station is used. Therefore, the checking of the station for measuring is performed at night in which an actual test is not performed. Accordingly, it is restrained that the checking of the station for measuring prevents an operation of the actual test.

### Second Embodiment

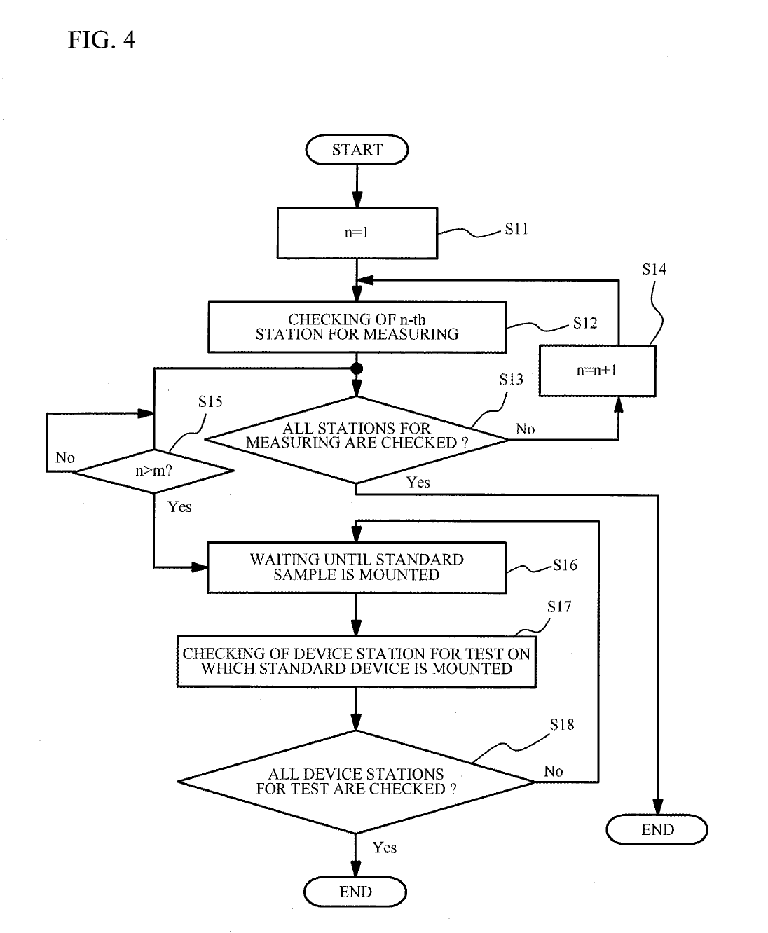

The checking of the device station 30 for test may start after a part of the stations 20 for measuring is checked. FIG. 4 illustrates a flowchart of another method for controlling the testing device 100. A description of Step S11 and Step S12 of FIG. 4 is the same as that of Step S1 and Step S2 of FIG. 3 and is omitted. After the execution of Step S12, the outer controller 10 determines whether all of the stations 20 for measuring are checked (Step S13). And, the outer controller 10 determines whether the variable “n” is larger than a threshold “m” (<n) (Step S15). The threshold “m” is an optional value. For example, the threshold “m” is n/2.

If it is determined “no” in Step S13, the outer controller 10 substitutes “n+1” into the variable “n” (Step S14). After that, the outer controller 10 executes Step S12 again. If it is determined “yes” in Step S13, the checking of the station 20 for measuring is finished.

If it is determined “no” in Step S15, the outer controller 10 waits. If it is determined “yes” in Step S15, the outer controller 10 waits until the standard sample is mounted on the mount portion 31 of the device station 30 for test that is not checked (Step S16). In this case, the outer controller 10 checks the station 20 for measuring in parallel until all of the stations 20 for measuring are checked. Step S17 and Step S18 are the same as Step S6 and Step S7 of FIG. 3. So, description of Step S17 and A18 are omitted.

In accordance with the second embodiment, the checking of the device station 30 for test starts before all of the stations 20 for measuring are checked. In this case, the time until the device station 30 for test is checked is reduced. When one or more device station 30 for test is checked, an actual testing may start on ahead by a combination of that wherein the station 20 for measuring and the device station 30 for test are checked each.

### Third Embodiment

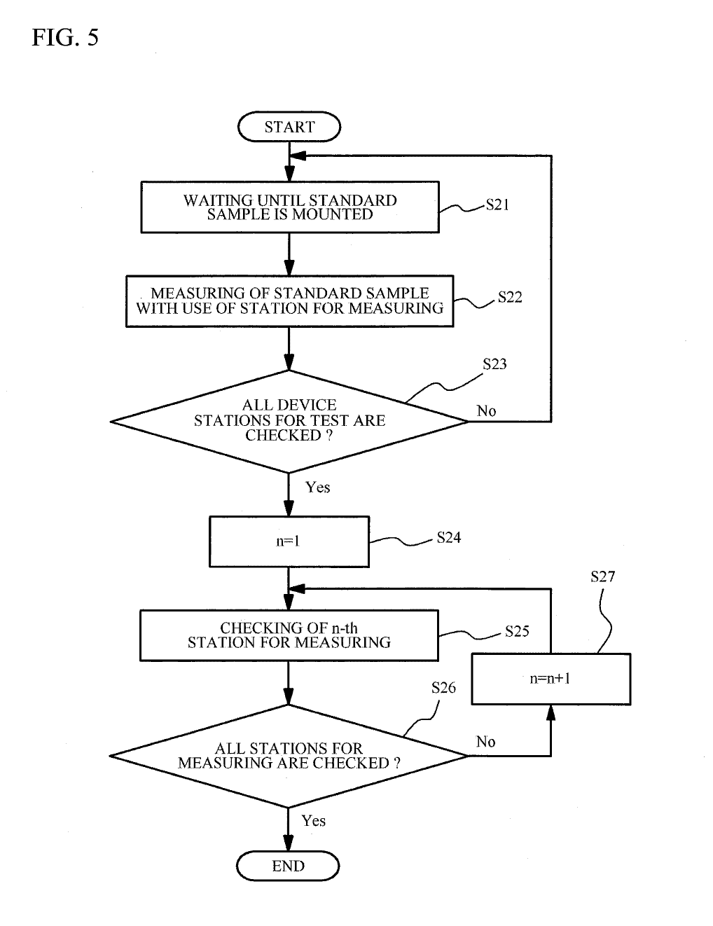

The checking of the device station 30 for test may start before the checking of the station 20 for measuring. FIG. 5 illustrates another example of a flowchart of a method for controlling the testing device 100. The outer controller 10 waits until the standard sample is mounted on the mount portion 31 of the device station 30 for test that is not checked (Step S21).

After the standard sample is mounted on the mount portion 31 of the device station 30 for test that is not checked, the outer controller 10 measures the standard sample with use of one of the measuring devices 21 (Step S22). Next, the outer controller 10 determines whether all of the device stations for test are checked (Step S23). If it is determined “no” in Step S23, the outer controller 10 executes Step S21 again.

If it is determined “yes” in Step S23, the outer controller 10 substitutes “1” into the variable “n” (Step S24).

Next, the outer controller 10 checks the measuring device 21 of nth station 20 for measuring with use of the standard device 54 of the standard station 50 (Step S25). Then, the outer controller 10 determines whether all of the stations 20 for measuring are checked (Step S26). If it is determined “no” in Step S26, the outer controller 10 substitutes “n+1” into the variable “n” (Step S27). After that, the outer controller 10 executes Step S25 again.

If it is determined “yes” in Step S26, the outer controller 10 terminates the flowchart.

In accordance with the third embodiment, the checking of the device station 30 for test starts before the checking of the station 20 for measuring. For example, the checking method is effective when the reliability of the station for measuring is relatively high.

### Fourth Embodiment

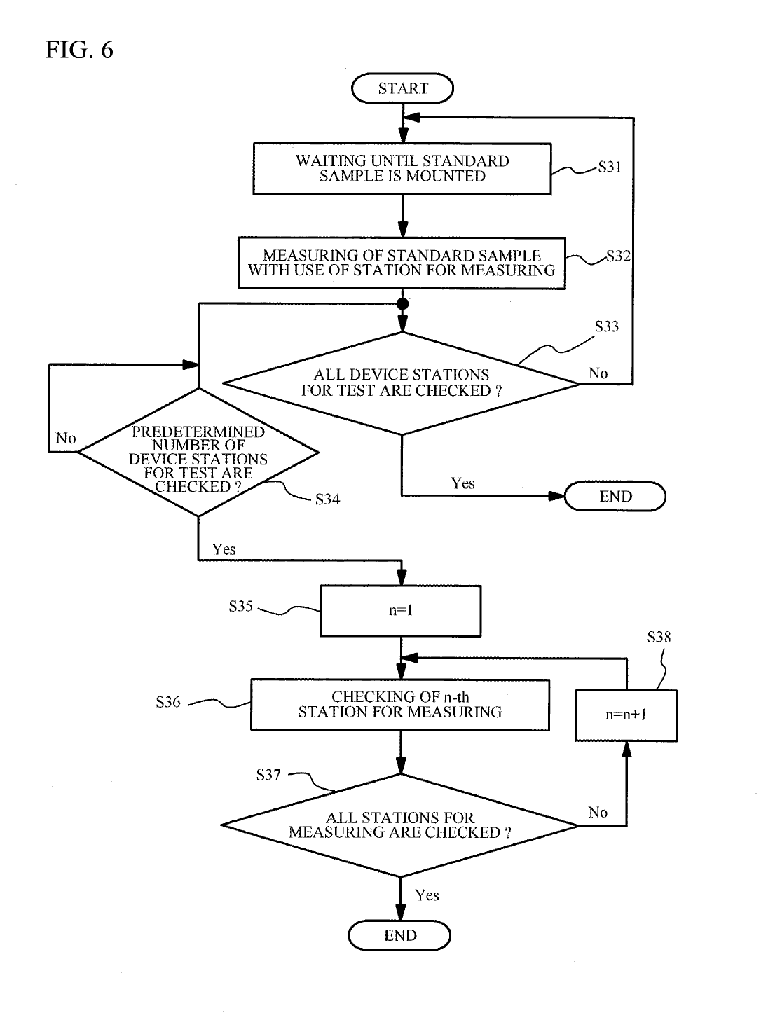

The checking of the station 20 for measuring may start after a part of the device stations 30 for test is checked. FIG. 6 illustrates an example of a flowchart of a method for controlling the testing device 100. Step S31 and Step S32 are the same as Step S21 and Step S22 of FIG. 5. Description of Step S31 and Step S32 are omitted. After the execution of Step S32, the outer controller 10 determines whether all of the device stations 30 for test are checked (Step S33). And, the outer controller 10 determines whether a predetermined number of the device stations 30 for test are checked (Step S34).

If it is determined “no” in Step S33, the outer controller 10 executes Step S31 again. If it is determined “yes” in Step S33, the checking of the device station 30 for test is finished.

If it is determined “no” in Step S34, the outer controller 10 waits. If it is determined “yes” in Step S34, the outer controller 10 executes Step S35. Steps S35 through S38 are the same as Steps 24 through 27 of FIG. 5. Description of Steps S35 through S38 is omitted.

In accordance with the fourth embodiment, the checking of the measuring device 21 starts before all of the device stations 30 for test are checked. In this case, the time until the checking of the measuring device 21 is finished.

### Fifth Embodiment

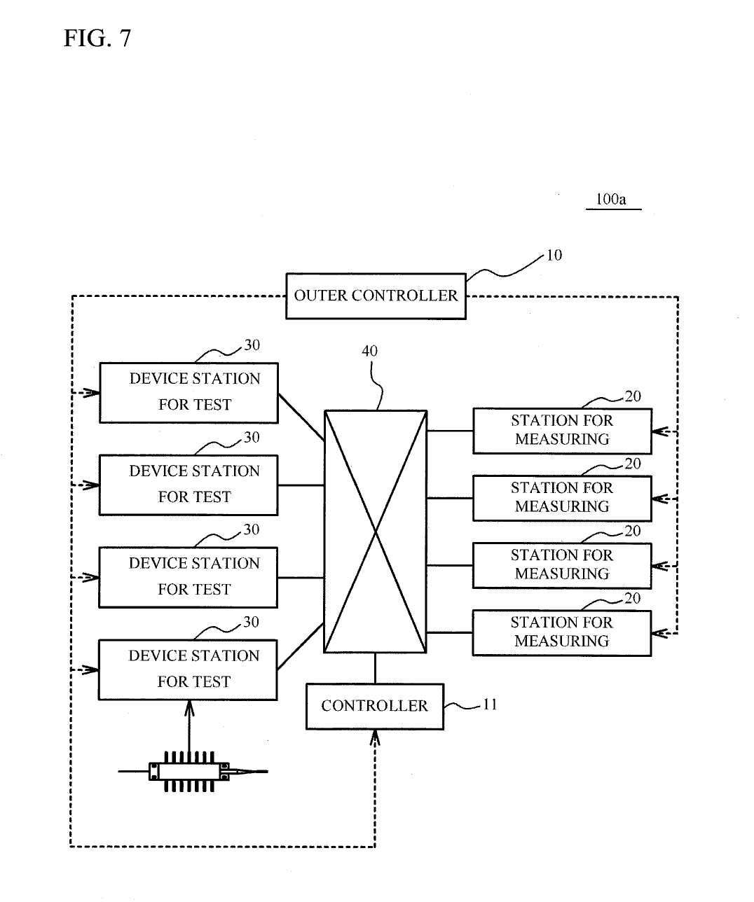

The standard station 50 may not be provided. FIG. 7 illustrates a schematic view of a testing device 100a in accordance with a fifth embodiment. As illustrated in FIG. 7, the testing device 100a does not have the standard station 50. In this case, each station 20 for measuring may be checked, when the standard device is mounted on one of the device stations 30 for test and the standard device is measured with use of a plurality of the stations 20 for measuring.

In the above mentioned embodiments, a single type of station 20 for measuring that measures identical characteristics is provided. However, the structure is not limited to the above-mentioned embodiments. When a plurality of stations for measuring that measure different characteristics are provided, the checking step of the station for measuring and the checking step of the device station for test may be separately performed with respect to each type of station for measuring in accordance with the flowcharts of FIG. 3 through FIG. 6. When the number of the station for measuring that measures different characteristics is only one, a plurality of the device stations may be checked with use of the one station for measuring.

In the above-mentioned embodiments, the outer controller 10 controls the testing device 100. However, the structure is not limited to the above-mentioned embodiments. The outer controller 10 may be replaced by one of the controllers 11, 22, 33 and 52.

The outer controller 10 may have a table of a check history of each of the station 20 for measuring and the device station 30 for test, a condition of the checking, and so on. In the checking, the outer controller 10 may determine necessity of checking or may control refusal against a request of the normal test being checked with reference to the table.

In the above-mentioned embodiment, one-to-one coupling may be checked with use of the measuring device 21 not subjected to the checking step of measuring device and the device station 30 for test not subjected to the checking step of device station for test. In this case, checking efficiency is improved.

The present invention is not limited to the specifically disclosed embodiments and variations but may include other embodiments and variations without departing from the scope of the present invention.

What is claimed is:

1. A method for controlling testing apparatus having a plurality of device stations for test, a plurality of measuring portions measuring an identical item, and a matrix switch changing a coupling combination between the plurality of the device stations for test and the plurality of the measuring portions,
comprising:
performing checking step of a measuring portion with respect to the plurality of the measuring portions, the checking step measuring the measuring portion by measuring a standard device; and
performing checking step of a device station for test with respect to the plurality of the device stations for test, the checking step mounting a standard sample on the device station for test and checking the standard sample with use of one of the measuring portions coupled to the device station for test on which the standard sample is mounted.

2. The method as claimed in claim 1, wherein the checking step of a device station for test is performed after the checking step of a measuring portion.

3. The method as claimed in claim 1,
wherein:
a part of the plurality of the measuring portions is subjected to the checking step of a measuring portion on ahead; and
the rest of the plurality of the measuring portions is subjected to the checking step of a measuring portion at the same time of the checking step of a device station for test or after the checking step of a device station for test.

4. The method as claimed in claim 1, wherein the checking step of a measuring portion is performed after the checking step of a device station for test.

5. The method as claimed in claim 1,
wherein:
a part of the device stations for test is subjected to the checking step of a device station for test on ahead; and
the rest of the device station for test is subjected to the checking step of a device station for test at the same time of the checking step of a measuring portion or after the checking step of a measuring portion.

6. The method as claimed in claim 1, wherein the standard device is mounted on the device station for test and is coupled to the measuring portion in the checking step of a measuring portion.

7. The method as claimed in claim 1,
wherein:
the testing device has a standard station on which a standard device and a drive portion driving the standard device are mounted, in addition to the device station for test; and
the checking step of a measuring portion is a step of measuring the standard device mounted on the standard station.

8. The method as claimed in claim 1 further comprising another step of performing the checking step of a device station for test with respect to a combination of the measuring portion and the device station for test that are not being checked, during the checking step of a measuring portion and the checking step of a device station for test.

9. A testing apparatus comprising:
a plurality of device stations having a device for test and a drive portion driving the device for the test;
a plurality of measuring portions measuring an identical item;
a standard station having a standard device and a drive portion driving the standard device; and
a matrix switch connecting between the device stations or the standard station and the plurality of the measuring portions.
